(19) United States
(12) Patent Application Publication
(10) Pub. No.: US 2012/0035784 A1
(43) Pub. Date: Feb. 9, 2012

(54) Method for stabilizing a vehicle having an integrated rollover prevention function

(76) Inventor: Andreas Gauger, Brackenheim (DE)

(21) Appl. No.: 13/138,370

(22) PCT Filed: Dec. 21, 2009
(86) PCT No.: PCT/EP2009/067662

§ 371 Date: Oct. 25, 2011

(30) Foreign Application Priority Data
Feb. 17, 2009 (DE) 10 2009 000 922.1

(51) Int. Cl. G06F 19/00

(52) U.S. Cl. 701/1

(57) ABSTRACT

A device for regulating the driving dynamics of a motor vehicle. A setpoint variable (ψ) for regulating the transverse dynamics of the vehicle is predefined and limited to a maximum value that is set in such a way that the transverse acceleration (a_{y}) of the vehicle does not exceed a predefined threshold value (a_{y}^{max}). In this way, the vehicle is prevented from driving in too tight a curve radius and rolling over.

### BACKGROUND OF THE INVENTION

1. Field of the Invention

The present invention relates to a device for regulating the driving dynamics of a vehicle and a corresponding method for regulation.

2. Description of Related Art

Known vehicle dynamics control systems, such as ESP, normally regulate the yaw rate and the float angle of a vehicle. To that end, it must be determined how the vehicle should behave (setpoint values) and how it actually behaves (actual values). The setpoint values are normally calculated in such a way that the vehicle follows as closely as possible the trajectory specified by the driver via the steering wheel and accelerator pedal position (driver input). It is problematic in this connection that the vehicle dynamics control system also regulates the vehicle based on the trajectory intended by the driver even in critical rollover situations. As a result, the vehicle may experience an excessively high transverse acceleration and roll over.

Separate devices which intervene in vehicle operation in the case of an excessively high transverse acceleration and stabilize the vehicle, for example, by automatic brake or steering interventions, are known for preventing a vehicle from rolling over. For example, it is known from published international patent application document WO 99/37516 to determine the rollover tendency of a vehicle and to use that to regulate the vehicle's transverse dynamics in such a way that the vehicle does not roll over. It is known from published international patent application document WO 2006/018439 A1 to detect a rollover based on various predefined driving states for a vehicle. However, all systems have in common that in addition to the vehicle dynamics control system, they are implemented as a separate device having its own sensors and its own signal processing and therefore entail a considerable additional expense.

### BRIEF SUMMARY OF THE INVENTION

It is thus the object of the present invention to provide a device and a method, making it possible to implement a rollover prevention function in a substantially simpler manner.

An essential aspect of the present invention is that the rollover prevention function is integrated into a conventional vehicle dynamics control system, e.g. ESP, and the modified vehicle dynamics control system is used to force the vehicle onto a trajectory having a greater curve radius than intended by the driver. This limits the transverse acceleration acting on the vehicle. According to the present invention, a setpoint value generator which, taking the driver input into consideration, ascertains at least one setpoint value for the control system is provided for this purpose. In critical driving situations in which the transverse acceleration acting on the vehicle would become too great—if the vehicle dynamics control system were to follow the driver input—the setpoint value according to the present invention is limited to a maximum value. The maximum value must be set in such a way that the transverse acceleration of the vehicle does not exceed a threshold value, and thus the vehicle at least does not roll over. In critical situations in which the driver specifies too small a curve radius at an excessively high speed, the vehicle does not follow precisely the trajectory intended by the driver but instead follows a trajectory having a larger radius and completes a yawing motion having a lower yaw rate. In this manner, the buildup of an excessively high transverse acceleration is counteracted very early and harmonically so that the vehicle no longer rolls over. A simple limitation of the control system setpoint value thus makes it possible to implement a rollover prevention function together with a standard vehicle dynamics control system.

The transverse acceleration threshold value may, e.g., be defined as the value at which the vehicle would roll over. However, a lower value may also be selected.

A “vehicle dynamics control system” according to the present invention is preferably a system that regulates at least one driving dynamics state variable, such as the yaw rate and/or the float angle of the vehicle. The associated setpoint value generator preferably includes a mathematical vehicle model (algorithm) which calculates the setpoint value from various measured variables, such as the steering angle or the vehicle speed, and from estimated variables if necessary.

According to one preferred specific embodiment of the present invention, the setpoint value is calculated as a function of the transverse force acting on the front wheel and/or the rear wheel. In this connection, at least one of the transverse forces is limited to a value that is set in such a way that the transverse acceleration of the vehicle does not exceed the allowed threshold value. Preferably, the transverse force of the front wheels is limited.

### BRIEF DESCRIPTION OF THE DRAWINGS

The present invention will be explained in greater detail below by way of example with reference to the appended drawing.

FIG. 1 shows a block diagram of a vehicle dynamics control system of a vehicle.

FIG. 2 shows a schematic view of a single track model for a vehicle.

FIG. 3a shows a diagram for a steering angle over time.

FIG. 3b shows exemplary time characteristics for the roll angle of a vehicle with and without a setpoint value generator according to the present invention.

### DETAILED DESCRIPTION OF THE INVENTION

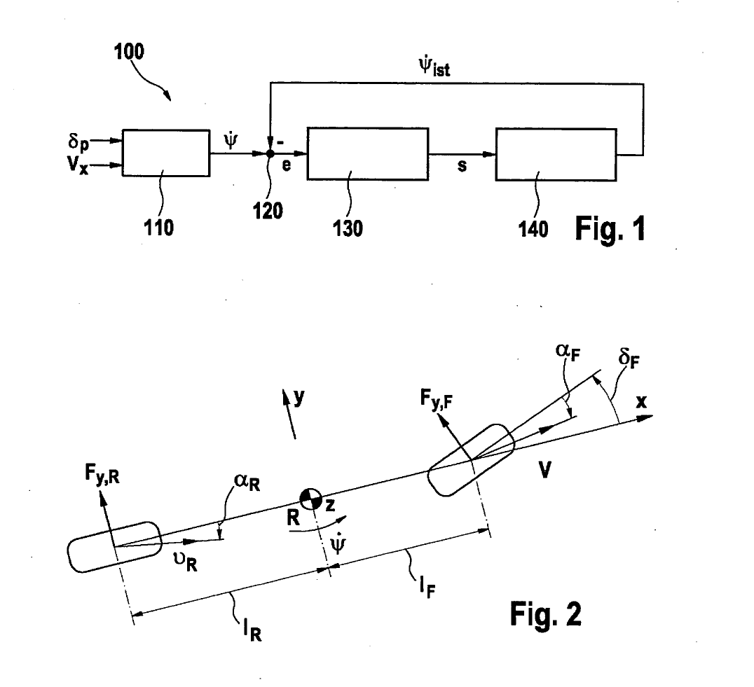

FIG. 1 shows a vehicle dynamics control system 100 for regulating the transverse dynamics of a vehicle having a control loop. Vehicle dynamics control system 100 includes a setpoint value generator 110 which in this case calculates a setpoint yaw rate \dot{ψ} for actual control system 130. Setpoint value generator 110 includes a mathematical vehicle model (algorithm), such as a single track model known from the related art, which calculates setpoint yaw rate \dot{ψ} while taking into consideration steering angle δ_{f} and longitudinal speed vₓ of the vehicle. The named variables are preferably measured.

Regulation difference e is calculated from setpoint yaw rate \dot{ψ} and actual yaw rate \dot{ψ}_{actual} at node 120, the regulation difference being output to vehicle dynamics control system 130. In the case of too high a regulation difference, vehicle dynamics control system 130 calculates an individual brake intervention s for each wheel, the brake intervention being implemented by the wheel brakes. The vehicle is shown schematically as a controlled system as block 140.

In contrast to conventional vehicle dynamics control systems, setpoint value \dot{ψ} is limited here to a value having a maximum amount such that the vehicle's transverse acceleration never increases above a threshold value. The transverse acceleration threshold value must be set in such a way that the vehicle at least does not roll over.

The vehicle model of setpoint value generator 110 is shown in FIG. 2. The associated model equations for determining setpoint yaw rate \dot{ψ} are:

$$\begin{matrix}\frac{d}{d t} {v}_{y} = \frac{1}{m} ( {F}_{y , F} ( {α}_{F} ) cos ( {δ}_{F} ) + {F}_{y , R} ( {α}_{R} ) ) - {v}_{x} \dot{ψ} & ( 1 ) \\ \frac{d}{d t} \dot{ψ} = \frac{1}{{J}_{z}} ( {F}_{y , F} ( {α}_{F} ) {l}_{F} cos ( {δ}_{F} ) - {F}_{y , R} ( {α}_{R} ) {l}_{R} ) & ( 2 )\end{matrix}$$

In addition to vehicle-specific variables, such as vehicle inertia J_{z} on the z axis, vehicle mass m and wheel spacings l_{F}, l_{R} of the front and rear wheels from vehicle center of gravity R, setpoint value generator 110 also requires measured variables, such as steering angle δ_{F} and longitudinal speed vₓ, for calculating setpoint yaw rate \dot{ψ}. Also required are time-dependent variables such as transverse force F_{y,F} of the front wheels (index F) and transverse force F_{y,R} of the rear wheels (index R), which may be calculated from measured variables and previous solutions of model equations (1), (2). An additional sensor for determining these variables is not absolutely necessary.

Transverse forces F_{y,F}, F_{y,R} are a non-linear function of respective slip angle α_{F}, α_{R} of the individual wheels. They may be determined, e.g., using a characteristic curve. Slip angles α_{F}, α_{R} are in turn a non-linear function of setpoint yaw rate \dot{ψ} and transverse speed v_{y}.

Using model equations (1), (2) in addition to setpoint yaw rate \dot{ψ}, setpoint value generator 110 also calculates transverse speed v_{y} and transverse acceleration a_{y} of the vehicle.

For determining instantaneous setpoint yaw rate \dot{ψ}, setpoint value generator 110 initially calculates instantaneous slip angle α_{F}, α_{R} based on the most recently calculated setpoint yaw rate \dot{ψ} and the most recently calculated transverse speed v_{y} and looks up associated transverse forces F_{y,F}, F_{y,R} on the individual wheels in the corresponding characteristic curve. If transverse forces F_{y,F}, F_{y,R} are so great that the transverse acceleration of the vehicle exceeds a maximum value a_{y}^{max}, at least one transverse force is limited. Setpoint yaw rate \dot{ψ} is then calculated based on limited transverse force F^{max}. The setting of this setpoint yaw rate using the vehicle dynamics control system ensures that the vehicle does not roll over.

The transverse acceleration of the reference model is determined by

$${a}_{y} = \frac{1}{m} ( {F}_{y , F} + {F}_{y , R} ) \qquad ( 3 )$$

In the present exemplary embodiment, transverse force F_{y,F} of the front wheels is limited. If a_{y}^{max} is the maximum allowed transverse acceleration, maximum allowed transverse force F_{y,F}^{max} is derived from (3) as follows:

F_{y,F}^{max}=m·a_{y}^{max}−|F_{y,R}| (4)

Setpoint value generator 110 now ascertains transverse force F_{y,F} of the front wheels and checks if it exceeds maximum transverse force F_{y,F}^{max}. If so, it uses limited value F_{y,F}^{max} as a basis in model equations (1), (2), otherwise it uses actually ascertained value F_{y,F}.

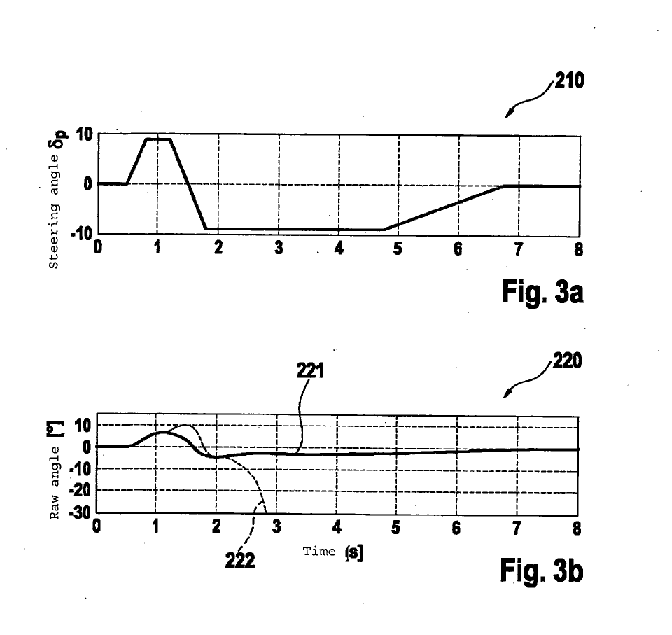

FIGS. 3a and 3b show the curve of various measured values in a vehicle which is regulated in one case with limitation and in one case without limitation of the setpoint yaw rate. As seen from diagram 210 for steering angle δ_{F}, the vehicle drives in an S-like curve.

Without limitation of setpoint yaw rate \dot{ψ}, the vehicle rolls over when driving in the S-like curve (see dashed line 222 in diagram 220). Initially the vehicle rocks 10° in one direction, then moves back into the neutral position and then rocks in the other direction, the roll angle being so great that the vehicle rolls over.

When setpoint yaw rate \dot{ψ} is limited, the vehicle does rock in the same driving maneuver (see continuous line 221) in both directions, but the roll angle in both cases remains less than 10° and the vehicle does not roll over.

1-8. (canceled)

9. A device for regulating the driving dynamics of a vehicle comprising:
a setpoint value generator for predefining a setpoint value for a control system that regulates the transverse dynamics of the vehicle,
wherein the setpoint value generator includes means for limiting the setpoint value to a maximum value.

10. The device as recited in claim 9, wherein the maximum value is set in such a way that the transverse acceleration of the vehicle does not exceed a threshold value.

11. The device as recited in claim 10, wherein the threshold value is lower than a limiting value at which the vehicle rolls over.

12. The device as recited in claim 9, wherein the setpoint value generator ascertains a setpoint yaw rate as a setpoint variable.

13. The device as recited in claim 10, wherein the setpoint value generator ascertains a setpoint yaw rate as a setpoint variable.

14. The device as recited in claim 11, wherein the setpoint value generator ascertains a setpoint yaw rate as a setpoint variable.

15. The device as recited in claim 9, wherein the setpoint value generator includes a mathematical model that ascertains the setpoint variable while taking into consideration a measured steering angle and a measured longitudinal speed.

16. The device as recited in claim 10, wherein the setpoint value generator includes a mathematical model that ascertains the setpoint variable while taking into consideration a measured steering angle and a measured longitudinal speed.

17. The device as recited in claim 11, wherein the setpoint value generator includes a mathematical model that ascertains the setpoint variable while taking into consideration a measured steering angle and a measured longitudinal speed.

18. The device as recited in claim 12, wherein the setpoint value generator includes a mathematical model that ascertains the setpoint variable while taking into consideration a measured steering angle and a measured longitudinal speed.

19. The device as recited in claim 9, wherein the setpoint value generator includes a mathematical model that ascertains the setpoint variable while taking into consideration a transverse force acting on at least one of a front and rear wheel of the vehicle.

20. The device as recited in claim 10, wherein the setpoint value generator includes a mathematical model that ascertains the setpoint variable while taking into consideration a transverse force acting on at least one of a front and rear wheel of the vehicle.

21. The device as recited in claim 11, wherein the setpoint value generator includes a mathematical model that ascertains the setpoint variable while taking into consideration a transverse force acting on at least one of a front and rear wheel of the vehicle.

22. The device as recited in claim 12, wherein the setpoint value generator includes a mathematical model that ascertains the setpoint variable while taking into consideration a transverse force acting on at least one of a front and rear wheel of the vehicle.

23. The device as recited in claim 15, wherein the setpoint value generator includes a mathematical model that ascertains the setpoint variable while taking into consideration a transverse force acting on at least one of a front and rear wheel of the vehicle.

24. The device as recited in claim 19, wherein the mathematical model limits at least one of the transverse force values so that the transverse acceleration of the vehicle does not exceed the predefined threshold value.

25. A method for regulating the driving dynamics of a vehicle, comprising:
ascertaining a setpoint variable for regulating the transverse dynamics of the vehicle and limiting the setpoint variable to be predefined to a maximum value that is set in such a way that the transverse acceleration of the vehicle does not exceed a threshold value.
